(19) United States
(12) Patent Application Publication
(10) Pub. No.: US 2011/0033207 A1
(43) Pub. Date: Feb. 10, 2011

(54) TONER USING RESIN BEING INSOLUBLE IN ORGANIC SOLVENTS AND METHOD FOR PREPARING THE SAME

(75) Inventors: Duck Kyun Ahn, Daejeon-City (KR); Woo Young Yang, Daejeon-City (KR); Keon II Kim, Daejeon-City (KR); Dae II Hwang, Daejeon-City (KR); II Hyuk Kim, Daejeon-City (KR); Jae Bum Park, Daejeon-City (KR); II Sun Hwang, Daejeon-City (KR); Jae Kwang Hwang, Daejeon-City (KR); Dae Woong Choi, Daejeon-City (KR); Dong Won Kim, Daejeon-City (KR)

Correspondence Address: Nixon Peabody LLP, P.O. Box 60610, Palo Alto, CA, 94306, US

(73) Assignee: SAMSUNG FINE CHEMICALS CO., LTD., Ulsan-city (KR)

(21) Appl. No.: 12/935,259

(22) PCT Filed: Mar. 26, 2009
(86) PCT No.: PCT/KR09/01547

§ 371 Date: Sep. 28, 2010

(30) Foreign Application Priority Data
Mar. 31, 2008 (KR) 10-2008-0029822

(51) Int. Cl. G03G 15/08; G03G 9/08; G03G 9/087

(52) U.S. Cl. 399/252; 430/105; 430/109.4; 430/137.18

(57) ABSTRACT

A toner using an organic solvent-insoluble resin and a method of preparing the same. The toner includes: a binder resin that comprises an organic solvent-insoluble resin and an acid group-containing resin, a coloring agent, and at least one additive, wherein the organic solvent-insoluble resin is a crosslinked polyester resin or a cyclic olefin co-polymer (COC) resin, and the ratio of the organic solvent-insoluble resin to the acid group-containing resin is in the range of 5:95 to 40:60 on a weight basis. The toner can be applied to an electrophotographic imaging apparatus.

### CROSS-REFERENCE TO RELATED PATENT APPLICATION

This application is a national phase of International Application No. PCT/KR2009/001547, entitled “TONER USING RESIN BEING INSOLUBLE IN ORGANIC SOLVENTS AND METHOD FOR PREPARING THE SAME”, which was filed on Mar. 26, 2009, and which claims priority to Korean Patent Application No. 10-2008-0029822, filed on Mar. 31, 2008, in the Korean Intellectual Property Office, the disclosure of which is incorporated herein in its entirety by reference.

### BACKGROUND OF THE INVENTION

1. Field of the Invention

The present invention relates to a toner and a method of preparing the same, and more particularly, to a toner having anti-hot offset properties by increasing a fixing temperature range, high storage stability at high temperature, and excellent charge stability against environmental changes, and a method of preparing the toner.

2. Description of the Related Art

Electrophotographic imaging apparatuses such as photocopiers and printers form an electrostatic latent image on a surface of a photoreceptor having photoconductivity and electrostatically adheres an insulated toner triboelectrically charged by a carrier or a charging unit to the electrostatic latent image to form a toner image. Then, the toner image is transferred onto a printing medium such as normal paper or printing paper and fixed by any of a variety of methods, including heating, pressurizing, solvent evaporation, and the like to form an image.

Meanwhile, as photocopiers, laser beam printers, or the like become smaller sized, and personalized, an increase in printing speed and a reduction in power consumption are required. In response to these demands for electrophotographic imaging apparatuses, diverse research is being conducted into improvement of properties of toner used for development in the electrophotographic imaging apparatuses. Furthermore, demand for toner suitable for high-speed printing, in particular, toner formed of polyester resins has been increasing in the printing industry in recent years.

In electrophotographic imaging apparatuses, toner is generally fixed by heat fixation with high thermal efficiency and high speed. The heat fixation is a method of fixing toner onto a printing medium by contacting the printing medium with a heating roller in a fixing unit. However, according to the heat fixation, hot offset that is a phenomenon in which some of toner adheres to the heating roller during a fixing process and is re-transferred to the printing medium to contaminate a subsequent image may occur. According to the heat fixation, a rolling phenomenon in which a printing medium is rolled up around a heating roller to stop the transfer of the printing medium, may also occur. These phenomena may be caused when viscoelasticity of toner that is melted by a heating roller is not suitable for printing. The viscoelasticity of toner may vary according to types of a binder resin that is a main component of the toner and types and contents of the remaining components.

Since environmental temperature varies and the temperature of the surface of a heating roller significantly varies by a plurality of consecutive printings when an image is formed, toner may have a wide fixing temperature range.

Generally, a styrene-acrylic resin or a polyester resin is used as a major resin of toner. The polyester resin has higher anti-hot offset properties and color forming properties but less charge stability according to environmental changes compared to the styrene-acrylic resin. Meanwhile, the styrene-acrylic resin has a lower hygroscopic property and better storage stability at high temperatures than the polyester resin.

In order to prevent hot offset and rolling phenomena and improve fixing properties at high temperatures, toner may include a releasing agent such as low molecular weight wax. However, when the releasing agent is used, toner particles may be melt-adhered to each other and toner may be melt-adhered to a charging unit constituting a developer, and thus toner may have poor fixing properties and cannot form uniform images. Accordingly, it is difficult to improve fixing properties of toner while preventing hot offset and rolling phenomena only with the use of the releasing agent.

In addition, in order to prevent the hot offset phenomenon, a method of coating the surface of a heating roller with a releasing layer is commonly used. The method includes forming the surface of the heating roller with a releasing material such as silicon rubber or a fluorine resin and coating the surface of the releasing material with a solution having a high releasing property such as silicon oil. However, according to the method, a device for coating the releasing solution is required and the releasing solution is evaporated by heat to contaminate inside the electrophotographic imaging apparatus. Furthermore, the electrophotographic imaging apparatus cannot be smaller sized due to the device for coating the releasing solution.

In order to overcome these problems, attempts have been made to improve properties of binder resins in order to prevent hot offsets.

Japanese Patent Publication No. 1995-027281 discloses a crosslinked polyester resin prepared by reacting etherified diphenol, dicarboxylic acid, and a trivalent or higher monomer and forming a crosslinked structure, as a binder resin having excellent anti-hot offset properties. However, fixing properties of the crosslinked polyester resin deteriorate.

Japanese Patent Publication No. 2003-156876 discloses an use of an ester wax to prevent hot offsets. However, a polyester resin has low compatibility with the ester wax so that the ester wax is separated from the polyester resin and the toner is peeled off while a toner image is formed and durability of toner deteriorates.

Japanese Patent No. 2988703 discloses an use of a crystalline polyester resin without a crosslinked structure to prevent hot offsets. However, a fixing temperature range narrows and hot offsets cannot be completely prevented.

Japanese Patent Publication Nos. 2002-023424 and 2003-156880 disclose an use of a polyester resin or a hybrid resin including a polyester unit and a vinyl co-polymer unit as a binder resin. However, anti-hot offset properties and durability of toner prepared using these resins deteriorate and peeling off of a toner occurs.

### SUMMARY OF THE INVENTION

The present invention provides a method of preparing a toner by which hot offsets are prevented in a wide temperature range by increasing a fixing temperature range.

The present invention also provides a method of preparing a toner by which storage stability is improved at high temperatures.

The present invention also provides a method of preparing a toner by which charge stability against environmental changes is improved.

The present invention also provides a toner prepared by using the method.

The present invention also provides an electrophotographic imaging apparatus using the toner.

According to an aspect of the present invention, there is provided a toner including:

a binder resin that includes an organic solvent-insoluble resin and an acid group-containing resin;

a coloring agent; and

at least one additive,

wherein the organic solvent-insoluble resin is a crosslinked polyester resin or a cyclic olefin co-polymer (COC) resin, and the ratio of the organic solvent-insoluble resin to the acid group-containing resin is in the range of 5:95 to 40:60 on a weight basis.

According to another aspect of the present invention, there is provided a method of preparing a toner, the method including:

dry-milling an organic solvent-insoluble resin to prepare fine particles or wet-dispersing the organic solvent-insoluble resin in an organic solvent to prepare a fine suspension;

adding an acid group-containing resin, a coloring agent, and at least one additive to an organic solvent and then mixing them to prepare a toner mixture;

adding the fine particles or fine suspension of the organic solvent-insoluble resin to the toner mixture to prepare an insoluble resin-toner mixture;

adding the insoluble resin-toner mixture to a dispersion medium to prepare a fine toner suspension; and

removing the organic solvent from the fine toner suspension to prepare a toner composition,

wherein the organic solvent-insoluble resin is a crosslinked polyester resin or a cyclic olefin co-polymer (COC) resin, and the ratio of the organic solvent-insoluble resin to the acid group-containing resin is in the range of 5:95 to 40:60 on a weight basis.

The method may further include neutralizing the acid group of the acid group-containing resin in the toner mixture or in the insoluble resin-toner mixture with a base after forming the toner mixture or forming the insoluble resin-toner mixture.

The method may further include aggregating the toner composition; melt-adhering the aggregated toner composition; and forming toner particles by washing and drying the melt-adhered toner composition, after preparing the toner composition.

A diameter of fine particles prepared by dry-milling the organic solvent-insoluble resin or fine particles in the fine suspension prepared by wet-dispersing the organic solvent-insoluble resin in an organic solvent may be in the range of 1 to 5 μm.

The acid group in the acid group-containing resin may include at least one selected from the group consisting of a carboxyl group, a phosphoric acid group, a sulfonic acid group, and a sulfuric acid group.

The acid group-containing resin may include a polyester resin.

The polyester resin may have an acid value in the range of 5 to 100 mgKOH/g.

The coloring agent may be in the form of a coloring pigment master batch.

The additive may include at least one selected from the group consisting of a charge control agent and a releasing agent.

The dispersion medium may include at least one selected from the group consisting of a polar solvent, a surfactant, and a thickener.

According to another aspect of the present invention, there is provided a electrophotographic imaging apparatus using the toner.

### DETAILED DESCRIPTION OF THE INVENTION

Hereinafter, the present invention will now be described in more detail.

A toner according to an embodiment of the present invention includes: a binder resin that includes an organic solvent-insoluble resin and an acid group-containing resin; a coloring agent; and at least one additive.

First, the organic solvent-insoluble resin (also referred to as insoluble resin) will be described.

An insoluble resin used herein refers to a crosslinked polyester resin or a crosslinked or non-crosslinked cyclic olefin co-polymer (COC) resin. The insoluble resin is used to improve fixing performance and resistance to hot offset of the toner.

The crosslinked polyester resin is formed by a reaction among:

a divalent or higher polybasic acid compound or derivatives thereof;

an aliphatic polyhydric alcohol including 60mol % to 100mol % of propylene glycol based on the amount of whole alcohol components; and

an epoxy compound.

Examples of the divalent or higher polybasic acid compound are dicarboxylic acid such as terephthalic acid, isophthalic acid, phthalic anhydride, adipic acid, maleic acid, maleic anhydride, fumaric acid, itaconic acid, citraconic acid, hexahydrophthalic anhydride, tetrahydrophthalic anhydride and cyclohexane dicarboxylic acid, or derivatives thereof.

Examples of the aliphatic polyhydric alcohol are 1,4-cyclohexane dimethanol, ethylene glycol, diethylene glycol, triethylene glycol, dipropylene glycol, tripropylene glycol, hexane diol, polyethylene glycol, and polypropylene glycol.

Examples of the epoxy compound as a crosslinking agent are bisphenol A type epoxy resin, bisphenol F type epoxy resin, bisphenol S type epoxy resin, ethylene glycol diglycidyl ether, N,N-diglycidyl aniline, glycerine ether, trimethylolpropane triglycidyl ether, cresol novolac epoxy resin, and a polymer of a vinyl compound having an epoxy group.

A glass transition temperature (Tg) of the crosslinked polyester resin may be in the range of 60 to 85° C., and preferably 60 to 75° C. In addition, a softening point of the crosslinked polyester resin may be in the range of 150 to 220° C., and preferably 160 to 190° C. If the glass transition temperature (Tg) and the softening point of the crosslinked polyester resin are less than their respective lowest limits, toner may be thermally aggregated (blocked) when exposed to high temperature in a developer of an electrophotographic imaging apparatus while toner is stored or transported. On the other hand, if the glass transition temperature (Tg) and the softening point of the crosslinked polyester resin are greater than their respective highest limits, fixing properties at low temperatures may deteriorate.

The cyclic olefin co-polymer (COC) resin is a polyolefin resin having a cyclic structure, and examples of the COC resin are a co-polymer of α-olefin such as ethylene, propylene, or butylene and an alicyclic compound having a double bond (i.e., cyclo olefin) such as cyclohexene, norbornene, and tetracyclododecene. The COC resin may be a random co-polymer or a block co-polymer. In the COC resin, the ratio of α-olefin to cyclo olefin may be adjusted by controlling the ratio between the amount of the α-olefin and the amount of the cyclo olefin to be used in the copolymerization reaction. For example, if ethylene as α-olefin and norbornene as cyclo olefin are used, the glass transition temperature (Tg) of the product (COC resin) is significantly influenced by the ratio between the amount of ethylene and the amount of norbornene used in the copolymerization reaction. When the amount of norbornene is increased, the glass transition temperature (Tg) tends to increase. In particular, when the amount of the norbornene is about 60% by weight, the glass transition temperature (Tg) may be in the range of about 60 to about 70° C. The COC resin may have a glass transition temperature (Tg) in the range of 40 to 80° C., a number average molecular weight (Mn) in the range of 100 to 20,000, and a weight average molecular weight (Mw) in the range of 7,000 to 400,000. The COC resin used herein may be a non-crosslinked COC resin or a COC resin that is crosslinked using any known method.

Next, an acid group-containing resin will be described.

The acid groups are introduced to the resin by chemical bonding. The acid group which may be neutralized by a base becomes an anion within an aqueous solution and has hydrophilic properties. Accordingly, the acid group-containing resin can be dispersed and stabilized in the particulate form within an aqueous solution. The acid group may include at least one selected from the group consisting of a carboxyl group, a phosphoric acid group, a sulfonic acid group, and a sulfuric acid group.

The acid group-containing resin may include a polyester resin which is suitable for dispersion of a coloring agent and fixing at low temperatures. The polyester resin includes a compound having an acid group which can be neutralized as an essential ingredient, and examples of the polyester resin are a carboxyl group-containing polyester resin, a sulfonic acid group-containing polyester resin, or a phosphoric acid-containing polyester resin. For example, the carboxyl group-containing polyester resin may be used. In this regard, the polyester resin may have an acid value in the range of 5 to 100 mgKOH/g. When the acid value is in the range of 5 to 100 mgKOH/g, the toner fine suspension which will be described later may be easily prepared, and the prepared toner has good environmental safety. For example, the acid value may be in the range of 7 to 30 mgKOH/g. Here, the polyester resin may be prepared by polymerization-condensation which is conducting by heating polyhydric alcohol components and polybasic carboxylic acid components under reduced pressure or in the presence of a catalyst. Examples of the polyhydric alcohol components are polyoxyethylene-(2.0)-2,2-bis(4-hydroxyphenyl)propane, polyoxypropylene-(2.0)-2,2-bis(4-hydroxyphenyl)propane, polyoxypropylene-(2.2)-polyoxyethylene-(2.0)-2,2-bis(4-hydroxyphenyl)propane, polyoxyethylene-(2.3)-2,2-bis(4-hydroxyphenyl)propane, polyoxypropylene-(6)-2,2-bis(4-hydroxyphenyl)propane, polyoxypropylene-(2.3)-2,2-bis(4-hydroxyphenyl)propane, polyoxypropylene-(2.4)-2,2-bis(4-hydroxyphenyl)propane, polyoxypropylene-(3.3)-2,2-bis(4-hydroxyphenyl)propane, polyoxyethylene-(6)-2,2-bis(4-hydroxyphenyl)propane, ethylene glycol, 1,3-propylene glycol, 1,2-propylene glycol, 1,4-butylene glycol, 1,3-butylene glycol, and glycerol polyoxypropylene. Examples of the polybasic carboxylic acid components are an aromatic polybasic acid and/or an alkyl ester thereof that are commonly used in the preparation of the polyester resin. Examples of the aromatic polybasic acid are terephthalic acid, isophthalic acid, trimellitic acid, pyromellitic acid, 1,2,4-cyclohexane tricarboxylic acid, 2,5,7-naphthalene tricarboxylic acid, 1,2,4-naphthalene tricarboxylic acid, 1,2,5-hexane tricarboxylic acid, 1,2,7,8-octane tetracarboxylic acid, and/or alkyl esters of these carboxylic acids, wherein the alkyl group may be a methyl group, an ethyl group, a propyl group and a butyl group. The aromatic polybasic acid and/or alkyl esters thereof may be used alone or in combination of at least two or more.

The content of the acid group-containing resin may be in the range of 50 to 95 parts by weight based on 100 parts by weight of the total toner composition. When the content of the acid group-containing resin is in the range of 50 to 95 parts by weight based on 100 parts by weight of the total toner composition, the resin can sufficiently bind the toner composition, and the amount of the toner composition except for the resin is large enough to preserve the function of the toner.

The ratio of the organic solvent-insoluble resin to the acid group-containing resin is in the range of 5:95 to 40:60 on a weight basis. The ratio of the organic solvent-insoluble resin to the acid group-containing resin is within the above range, the toner may have proper chargeability and thus high image density.

In this regard, the toner composition includes a coloring agent, additives, etc., which will be described later, in addition to the acid group-containing resin. The acid group-containing resin may have a number average molecular weight in the range of 2,000 to 10,000, a poly dispersity index (PDI) in the range of 2 to 15, and a THF(tetrahydrofuran)-insoluble content equal to or less than 1% by weight. When the number average molecular weight is in the range of 2,000 to 10,000, the melt viscosity is so high that the range of fixing temperature widens, and large particles are not formed while forming particles and thus particle dispersity narrows. Furthermore, when the PDI is in the range of 2 to 15, the fixing temperature range widens, and it is easy to obtain a resin having THF-insoluble content of less than 1% by weight and fine suspension particles are easily prepared.

Meanwhile, the coloring agent may be a dye or a pigment, and the pigment may be a coloring pigment master batch in which a high concentration of pigment is dispersed. The coloring pigment master batch indicates a resin composition in which a coloring pigment is uniformly dispersed. The coloring pigment master batch is prepared by blending a coloring pigment and a resin at high temperature and high pressure, or by dissolving a resin in a solvent, adding a coloring pigment to the solution and applying a high shearing force to the resulting solution to disperse the coloring pigment. A uniform fine suspension can be prepared by suppressing the exposure of a pigment in the preparation of toner fine suspension using the coloring pigment master batch. The resin used in the coloring pigment master batch may be an acid group-containing resin or any known resin.

The coloring pigment may be selected from pigments that are commonly and commercially used, such as a black pigment, a cyan pigment, a magenta pigment, a yellow pigment or a mixture thereof.

Generally, carbon black is used as the black pigment for the toner according to the present embodiment. Any carbon black may be used without limitation of number average particle diameter, specific surface area, or pH and the carbon black may be purchased from, for example, Cavot Corporation (U.S.A.) (REGAL 400, 660, 330, 300, SRF-S, STERLING SO, V, NS, and R); or Mitsubishi Chemical Corporation (Japan) (#5B, #10B, #40, 2400B, and MA-100). The carbon black may be used alone or in a combination of two or more.

Examples of the magenta pigment include C.I. pigment reds 1, 2, 3, 4, 5, 6, 7, 8, 9, 10, 11, 12, 13, 14, 15, 16, 17, 18, 19, 21, 22, 23, 29, 30, 31, 32, 35, 37, 38, 39, 40, 41, 48, 49, 50, 51, 52, 53, 54, 55, 57, 58, 60, 63, 64, 68, 81, 83, 87, 88, 89, 90, 112, 114, 122, 123, 163, 202, 206, 207, and 209; and C.I. pigment violet 19. The magenta pigment may be used alone or in a combination of two or more.

Examples of the cyan pigment include C.I. pigment blues 2, 3, 15, 16, and 17; C.I. vat blue 6; and C.I. pigment blue 45. The cyan pigment may be used alone or in a combination of two or more.

Examples of the yellow pigment include C.I. pigment yellows 1, 2, 3, 4, 5, 6, 7, 10, 11, 12, 13, 14, 15, 16, 17, 23, 65, 73, 74, 83, 93, 94, 97, 155, and 180. The yellow pigment may be used alone or in a combination of two or more.

A pigment for full color image may be prepared by using magenta pigments (C.I. pigment reds 57 and 122), cyan pigments (C.I. pigment blue 15), and yellow pigments (C.I. pigment yellows 17, 93, 155, and 180) in view of color mixing property and color reproduction property. The coloring agent may be used in an amount sufficient to color the toner and form a visible image by development, for example, 3 to 15 parts by weight based on 100 parts by weight of the acid group-containing resin. If the amount of the coloring agent is 3 to 15 parts by weight based on 100 parts by weight of the acid group-containing resin, coloring effects are sufficient, and high electric resistance of toner may be maintained and thus a sufficient frictional charge amount may be obtained, thereby not causing contamination.

Meanwhile, the additive may include a charge control agent, a releasing agent or a mixture thereof.

The charge control agent may be a positive charge control agent or a negative charge control agent.

Examples of the positive charge control agent are nigrosine and products of nigrosine modified with a fatty acid metal salt, a quaternary ammonium salt such as tributylbenzylammonium-1-hydroxy-4-naphthosulfonate and tetrabutylammonium tetrafluoroborate; diorganotin oxide such as dibutyltin oxide, dioctyltin oxide, and dicyclohexyltin oxide; diorganotin borate such as dibutyltin borate, dioctyltin borate, and dicyclohexyltin borate; pyridium salt; azine; a triphenylmethane-based compound; and a low molecular weight polymer having a cationic functional group. The positive charge control agent may be used alone or in a combination of two or more. For example, the positive charge control agent may be a nigrosine-based compound or the quaternary ammonium salt.

Examples of the negative charge control agent are an acetylacetone-based metal complex, mono azo-based metal complex, naphthoic acid or a salicylic acid-based metal complex, chelate, and a low molecular weight polymer having an anionic functional group. The negative charge control agent may be used alone or in a combination of two or more. For example, the negative charge control agent may be the salicylic acid-based metal complex or the mono azo-based metal complex.

Since the charge control agent stably and quickly charges toner by its electrostatic force, the toner may be stably supported on a developing roller.

The amount of the charge control agent contained in toner may be in a range of 0.1 to 10 parts by weight based on 100 parts by weight of the toner composition. When the amount of the charge control agent is in a range of 0.1 to 10 parts by weight based on 100 parts by weight of the toner composition, toner is charged rapidly and the charged amount is high enough to function as a charge control agent without any distortion of images.

The toner according to the present embodiment may include a releasing agent for improving fixing properties of a toner image. Examples of the releasing agent include polyolefin wax such as polyethylene wax, polypropylene wax, and modified polyethylene wax; synthesized wax such as Fischer-Tropsch wax; petroleum-based wax such as paraffin wax and microcrystalline wax; carbauna wax; candelilla wax, rice wax; and hydrogenated castor oil.

In addition, the additive may also be higher fatty acid or fatty acid amide, or metal salts thereof, or the like. The higher fatty acid, the fatty acid amid, and the metal salts thereof may be used in order to prevent deterioration of developing properties and thus to obtain high quality images.

In addition, the toner may include any known additive such as a lubricant, a flowability enhancer, an abrasive, a conductivity provider, and an anti-peeling agent for a toner image which may be used as internal or external additives. Examples of the lubricant are polyvinylidene fluoride and zinc stearate, examples of the flowability enhancer are silica prepared by a dry or wet process, aluminum oxide, titanium oxide, silicon aluminum cooxide, silicon titanium cooxide, and hydrophobicized products thereof, examples of the abrasive are silicon nitride, cerium oxide, silicon carbide, strontium titanate, tungsten carbide, calcium carbonate, and hydrophobicized products thereof, and examples of the conductivity provider are carbon black and tin oxide. In addition, fine powder of a fluorine-containing polymer such as polyvinylidene fluoride may be used to improve flowability, abradability, and charging stability.

The toner according to the present embodiment may include hydrophobicized powder, e.g., powder of hydrophobicized silica, hydrophobicized silicon aluminum cooxide, and/or hydrophobicized silicon titanium cooxide, as external additives. The powder may be one that is hydrophobicized using a silane coupling agent such as tetramethyldisilazane, dimethyldichlorosilane, and dimethyldimethoxysilane. The amount of the hydrophobicized powder such as hydrophobicized silica may be in the range of 0.01 to 20 parts by weight, for example, 0.03 to 5 parts by weight based on 100 parts by weight of the total toner composition.

Hereinafter, a method of preparing a toner according to an embodiment of the present invention will be described in detail.

First, an organic solvent-insoluble resin is dry-milled to prepare fine particles or wet-dispersed in an organic solvent to prepare a fine suspension.

Then, an acid group-containing resin, a coloring agent, and at least one additive are added to an organic solvent and mixed at a temperature of 40 to 95° C. to prepare a toner mixture. Then, the acid group of the resin is neutralized with a base. However, the present disclosure is not limited thereto. The neutralization of the acid group may be conducted after forming an insoluble resin-toner mixture which will be described later.

Then, the fine particles or fine suspension of the insoluble resin are added to the toner mixture to prepare an insoluble resin-toner mixture. Meanwhile, the insoluble resin-toner mixture may also be prepared by adding the acid group-containing resin, the coloring agent, at least one additive, and the fine particles or fine suspension of the insoluble resin to an organic solvent and mixed, and then neutralizing the acid group with a base.

Then, the insoluble resin-toner mixture is added to a dispersion medium including a polar solvent, a surfactant, and optionally a thickener at a temperature in the range of 60 to 98° C. and stirred to form a toner fine suspension.

Then, the toner fine suspension is stirred at a temperature in the range of 60 to 98° C., and the organic solvent is removed by evaporation to form a toner composition.

Then, an aggregating agent is added to the formed toner composition, and the temperature, pH, and the like are adjusted to aggregate the resultants. Here, the aggregated toner composition has low rigidity and an irregular shape.

Then, the aggregated toner composition is melt-adhered to obtain a toner composition having a desired particle size. By such melt-adhesion, the rigidity of the toner composition is increased, and the shape becomes regular. In addition, the shape of the toner composition may change to have various shapes from a contorted sphere to a complete spherical shape according to the degree of the melt-adhesion.

Finally, the melt-adhered toner composition is cooled, washed, and dried to obtain toner particles.

The organic solvent used herein is volatile, has a lower boiling point than a polar solvent, and is not miscible with the polar solvent. The organic solvent may include at least one selected from the group consisting of esters such as methyl acetate or ethyl acetate; ketones such as acetone or methylethyl ketone; hydrocarbons such as dichloromethane or trichloroethane; and aromatic hydrocarbons such as benzene.

The polar solvent may include at least one selected from the group consisting of water, glycerol, ethanol, ethylene glycol, propylene glycol, diethylene glycol and dipropylene glycol, sorbitol.

The thickener may be polyvinyl pyrrolidone, polyvinyl alcohol, polyacrylic acid, gelatin, chitosan and sodium alginate.

The surfactant may include at least one selected from the group consisting of a nonionic surfactant, an anionic surfactant, a cationic surfactant, and an amphoteric surfactant.

Examples of the nonionic surfactant include polyvinyl alcohol, polyacrylic acid, methylcellulose, ethylcellulose, propylcellulose, hydroxyethylcellulose, carboxymethylcellulose, polyoxyethylene cetyl ether, polyoxyethylene lauryl ether, polyoxyethylene octylphenyl ether, polyoxyethylene stearyl ether, polyoxyethylene norylphenyl ether, ethoxylate, phosphate norylphenols, triton, and dialkylphenoxypoly(ethyleneoxy)ethanol. Examples of the anionic surfactant include sodium dodecyl sulfate, sodium dodecyl benezene sulfonate, sodium dodecyl naphthalene sulfate, dialkyl benzenealkyl sulfate, and sulfonate. Examples of the cationic surfactant include alkyl benzene dimethyl ammonium chloride, alkyl trimethyl ammonium chloride, and distearyl ammonium chloride. Examples of the amphoteric surfactant include amino acid-type amphoteric surfactant, betaine amphoteric surfactant, lecitin, and taurin.

The surfactants described above may be used alone or in a combination of two or more.

The neutralizer used to neutralize the acid groups may be, for example, an alkaline metal hydroxide such as sodium hydroxide and lithium hydroxide; a carbonate of an alkaline metal such as sodium, potassium and lithium; an alkaline metal acetate; and alkanolamines such as ammonium hydroxide, methylamine and dimethylamine, and preferably an alkaline compound. For example, the alkaline metal hydroxide may be used.

The neutralizer may be used at 0.1 to 3.0 equivalents, for example 0.5 to 2.0 equivalents, per 1 equivalent of the acid group of the acid group-containing resin.

The aggregating agent may be a surfactant used in the dispersion medium, a surfactant having a polarity opposite to that of the surfactant used in the dispersion medium, or a monovalent or higher inorganic metal salt.

In general, as an ionic charge number increases, aggregating forces increase. Thus, an aggregating agent is selected in consideration of the aggregating speed and stability. The monovalent or higher inorganic metal salt may be calcium chloride, calcium acetate, barium chloride, magnesium chloride, sodium chloride, sodium sulfate, ammonium sulfate, magnesium sulfate, sodium phosphate, sodium biphosphate, ammonium chloride, cobalt chloride, strontium chloride, cesium chloride, nickel chloride, rubidium chloride, potassium chloride, sodium acetate, ammonium acetate, potassium acetate, sodium benzoate, aluminum chloride, zinc chloride, or the like.

The toner prepared by the method according to the present embodiment may be applied to an electrophotographic imaging apparatus. In this regard, the electrophotographic imaging apparatus includes laser printers, photocopiers, and facsimiles.

Hereinafter, one or more embodiments will be described in detail with reference to the following examples. However, these examples are not intended to limit the purpose and scope of the invention.

### Preparation Examples

Synthesis of Polyester Resin

### Preparation Example 1

A 3 L reactor equipped with a stirrer, a thermometer, and a condenser was installed in an oil bath including a heating medium. A variety of monomers, that is, 50 parts by weight (50 g) of dimethyl terephthalate, 47 parts by weight (47 g) of dimethyl isophthalate, 80 parts by weight (80 g) of 1,2-propylene glycol, and 3 parts by weight (3 g) of trimellitic acid were added to the reactor. Then, 9 mg of dibutyl tin oxide was added thereto as a catalyst, corresponding to 500 ppm with respect to the total weight of the monomers. Then, the reaction temperature was increased to 150° C. while stirring the mixture at a speed of 150 rpm. The reaction was performed for about 6 hours, and the reaction temperature was increased to 220° C. The pressure of the reactor was reduced to 0.1 torr in order to remove byproducts, and the reaction was completed after being maintained at that pressure for 15 hours. As a result, a polyester resin was obtained. The glass transition temperature (Tg) of the polyester resin measured using a differential scanning calorimeter (DSC) was 62° C. The number average molecular weight and poly dispersity index (PDI) of the polyester resin were measured by gel permeation chromatography (GPC) using polystyrene as a standard sample and were respectively 4,300 and 3.5. An acid value measured by titration was 15 mgKOH/g.

Preparation of Coloring Pigment Master Batch

### Preparation Example 2

### Preparation of Black Pigment Master Batch

The polyester resin synthesized in Preparation Example 1 and a carbon black pigment (Degussa GmbH of Germany, NIPEX 150) were mixed at a weight ratio of 8:2. Then, 50 parts by weight of ethyl acetate based on 100 parts by weight of the polyester resin was added thereto, and the mixture was heated to about 60° C., and then mixed with a kneader for 1 hour. Then, while the mixture was mixed at a rate of 50 rpm using a biaxial extruder connected to a vacuum device, ethyl acetate as a solvent was removed using the vacuum device to obtain a black pigment master batch.

### Preparation Example 3

### Preparation of Cyan Pigment Master Batch

A cyan pigment master batch was prepared in the same manner as in Preparation Example 2, except that the polyester resin synthesized according to Preparation Example 1 and a cyan pigment (C.I. pigment blue 15:3, color index No. 74160, manufactured by DIC, Japan) were mixed in a weight ratio of 6:4.

### Preparation Example 4

### Preparation of Magenta Pigment Master Batch

A magenta pigment master batch was prepared in the same manner as in

Preparation Example 2, except that the polyester resin synthesized according to Preparation Example 1 and a magenta pigment (Red 122, manufactured by DIC, Japan) were mixed in a weight ratio of 6:4.

### Preparation Example 5

### Preparation of Yellow Pigment Master Batch

A yellow pigment master batch was prepared in the same manner as in Preparation Example 2, except that the polyester resin synthesized according to Preparation Example 1 and a yellow pigment (manufactured by Clariant, Germany) were mixed in a weight ratio of 6:4.

Preparation of Fine Particles of Organic Solvent-Insoluble Resin

### Preparation Example 6

### Preparation of Fine Suspension of Crosslinked Polyester Resin

500 g of crosslinked polyester (manufactured by Mitsui Chem., Model No.: XPE-3202, Tfb: 126° C., T½: 181° C.) and 500 g of methylethyl ketone were stirred at 2000 rpm for 2 hours using a homogenizer to prepare a fine suspension. As a result of measuring the size of fine particles in the fine suspension using a Coulter Multisizer (Beckman Coulter Co.), it was determined that the volume average particle diameter was 2.5 μm.

### Preparation Example 7

### Preparation of Fine Particles of Cyclic Olefin Co-Polymer (COC) Resin

500 g of COC resin (ethylene-norbornene co-polymer, manufactured by Ticona, Model No.: TOPAS COC, number average molecular weight (Mn): 5,000, weight average molecular weight (Mw): 200,000) was pulverized using a jet mill to prepare fine particles. As a result of measuring the size of fine particles using a Coulter Multisizer (Beckman Coulter Co.), it was determined that the volume average particle diameter was 2.4 μm.

Preparation Toner Particles

### Example 1

170 g of polyester resin synthesized in Preparation Example 1, 30 g of crosslinked polyester resin (solid content) synthesized in Preparation Example 6, 80 g of black pigment master batch synthesized in Preparation Example 2, 2 g of a charge control agent (N-23, HB Dinglong Co.), 8 g of paraffin wax, and 300 g of methylethyl ketone as an organic solvent were added to a 1 L reactor equipped with a condenser, a thermometer, and an impeller stirrer. While the mixture was stirred at a rate of 600 rpm, 50 ml of 1N NaOH solution was added thereto. Then, the mixture was mixed at 80° C. for 5 hours while refluxing. When the mixture had sufficient fluidity, it was further stirred at 500 rpm for 2 hours. As a result, an insoluble resin-toner mixture was obtained.

800 g of distilled water, 10 g of a neutral surfactant (Tween 20, Aldrich Co.), and 2 g of sodium dodecyl sulfate (Aldrich Co.) as an anionic surfactant were added to a separate 3 L reactor equipped with a condenser, a thermometer and an impeller stirrer, and the mixture was stirred at 85° C. at 600 rpm for 1 hour to obtain a dispersion medium.

The insoluble resin-toner mixture was added to the dispersion medium and stirred at 85° C., at 1000 rpm for 1 hour to prepare a toner fine suspension. Then, methylethyl ketone as an organic solvent was removed at a partially reduced pressure of 100 mmHg while the reactor was maintained at 90° C. As a result, a toner composition was obtained. As a result of measuring the size of the toner composition having no methylethyl ketone using a Coulter Multisizer (Beckman Coulter Co.), it was determined that the volume average particle size was 3.2 μm.

Then, the reactor was cooled to 40° C., 10 g of magnesium chloride dissolved in 50 g of distilled water was gradually added to the reactor, and the reactor was heated to 80° C. for 30 minutes to aggregate the toner composition. After 5 hours, as a result of measuring the size of the aggregated toner composition using a Coulter Multisizer (Beckman Coulter Co.), it was determined that the volume average particle size was 7.2 μm.

Then, melt-adhesion was performed at 80° C. for 8 hours by adding 500 g of distilled water to the reactor, and the reactor was cooled.

Then, the melt-adhered toner composition were separated using a filter that is commonly used in the art, washed with 1 N hydrochloric acid solution, and washed again 5 times with distilled water to completely remove a surfactant, and the like. Then, the washed toner particles were dried in a fluidized bed dryer at 40° C. for 5 hours to obtain dried toner particles.

As a result of analyzing the toner particles, it was determined that the obtained toner particles had a volume average particle size of 7.2 μm and a 80% span value of 0.65. An average circularity measured by using an FPIA-3000 (manufactured by Sysmex) was 0.95.

### Example 2

Toner particles were prepared in the same manner as in Example 1, except that 140 g of polyester resin synthesized in Preparation Example 1 and 60 g of crosslinked polyester resin (solid content) synthesized in Preparation Example 6 were used.

As a result of analyzing the toner particles, it was determined that the obtained toner particles had a volume average particle size of 6.8 μm and a 80% span value of 0.62. An average circularity measured by using an FPIA-3000 (manufactured by Sysmex) was 0.94.

### Example 3

Toner particles were prepared in the same manner as in Example 1, except that 100 g of polyester resin synthesized in Preparation Example 1 and 100 g of crosslinked polyester resin (solid content) synthesized in Preparation Example 6 were used.

As a result of analyzing the toner particles, it was determined that the obtained toner particles had a volume average particle size of 7.6 μm and an 80% span value of 0.72. An average circularity measured by using an FPIA-3000 (manufactured by Sysmex) was 0.93.

### Example 4

Toner particles were prepared in the same manner as in Example 1, except that 170 g of polyester resin synthesized in Preparation Example 1 and 30 g of COC resin fine particles synthesized in Preparation Example 7 as an insoluble resin were used.

As a result of analyzing the toner particles, the obtained toner particles had a volume average particle size of 7.0 μm and a 80% span value of 0.64. An average circularity measured by using an FPIA-3000 (manufactured by Sysmex) was 0.95.

### Example 5

Toner particles were prepared in the same manner as in Example 1, except that 140 g of polyester resin synthesized in Preparation Example 1 and 60 g of COC resin fine particles synthesized in Preparation Example 7 as an insoluble resin were used.

As a result of analyzing the toner particles, it was determined that the obtained toner particles had a volume average particle size of 7.2 μm and a 80% span value of 0.66. An average circularity measured by using an FPIA-3000 (manufactured by Sysmex) was 0.94.

### Example 6

Toner particles were prepared in the same manner as in Example 1, except that 100 g of polyester resin synthesized in Preparation Example 1 and 100 g of COC resin fine particles synthesized in Preparation Example 7 as an insoluble resin were used.

As a result of analyzing the toner particles, it was determined that the obtained toner particles had a volume average particle size of 7.5 μm and a 80% span value of 0.76. An average circularity measured by using an FPIA-3000 (manufactured by Sysmex) was 0.94.

### Comparative Example 1

Toner particles were prepared in the same manner as in Example 1, except that 160 g of polyester resin synthesized in Preparation Example 1 was used and an insoluble resin was not used.

As a result of analyzing the toner particles, it was determined that the obtained toner particles had a volume average particle size of 6.8 μm and a 80% span value of 0.75. The average circularity of toner was 0.95.

Volume average particles sizes of the toner according to Examples 1 to 6 and Comparative Example 1 were measured using a Coulter Multisizer 3. An aperture of 100 μm was used in the Coulter Multisizer 3, an appropriate amount of a surfactant was added to 50 to 100 ml of ISOTON-II (Beckman Coulter Co.) as an electrolyte, and 10 to 20 mg of a sample to be measured (i.e., toner particles) was added thereto. Then, the resultant was dispersed in a ultrasonic dispersion apparatus for 1 minute to prepare a sample for the Coulter Multisizer.

In addition, the 80% span value, indicating the particle size distribution, was calculated using Equation 1 below. The volume of toner particles is accumulated from particles of the smallest size in ascending order until the accumulated volume reaches 10% of the total volume of the toner. An average particle size of the accumulated particles corresponding to 10% of the total volume of the toner is defined as d10. Average particle sizes of the accumulated particles corresponding to 50% and 90% of the total volume of the toner are respectively defined as d50 and d90.

80% span value=(d90−d10)/d50 Equation 1

Here, a smaller span value indicates a narrower particle distribution, and a larger span value indicates a wider particle distribution.

A glass transition temperature (Tg) of a sample was measured using a differential scanning calorimeter (DSC, manufactured by Netzsch Co.) by heating the sample from 20 to 200° C. at 10° C./min, rapidly cooling it to 10° C. at 20° C./min, and heating it at 10° C./min.

The acid value (mgKOH/g) was measured by dissolving the resin in dichloromethane, cooling the solution, and titrating the solution with 0.1N KOH methyl alcohol solution.

The toner particles prepared as described above have various shapes with the average circularity in the range of 0.90 to 0.99, the volume average particle size in the range of 2 to 10 μm, and the 80% span value of 0.90 or less.

Toner particles prepared according to Examples 1 to 6 and Comparative Example 1 were evaluated as follows.

Storage Stability at High Temperature

10 g of toner particles, 0.2 g of silica (TG 810G, Cabot co.) and 0.05 g of silica (RX50, Degussa GmbH) were mixed to prepare 10.25 g of a toner composition. Then, the toner composition was added to a 25 ml glass bottle and maintained at 50° C. and 80% humidity for 72 hours. Storage stability at high temperature was evaluated by observing the toner composition with the naked eye. The results are shown in Table 1 as ◯, Δ, ×, which indicate the following properties:

◯: No flocculation, thus no problem.

Δ: Weak flocculation but flocculated particles are scattered when shaken; no substantial problem occurred when used.

×: Strong flocculation and the flocculated toner particles were not scattered; substantial problem occurred when used.

Fixing Temperature Range: An Indication of Resistance to Hot Offset

100 g of toner particles, 2 g of silica (TG 810G; Cabot Co.) and 0.5 g of silica (RX50, Degussa GmbH) were mixed to prepare a toner composition. Using the toner composition, unfixed images in a 30 mm×40 mm solid state were prepared by a Samsung CLP-510 printer. Then, the fixing properties of the unfixed images were evaluated while varying the temperature of a fixing roller at a fixing tester in which the fixing temperature could be controlled.

Charge Stability Against Environmental Changes

0.2 g of each of the toner compositions (prepared by mixing 100 g of toner particles synthesized in Examples 1 to 6 and Comparative Example 1, 2 g of silica (TG 810G; Cabot), and 0.5 g of silica (RX50, Degussa)) maintained under three environmental conditions (changes in temperature/humidity) as shown in Table 1 for 16 hours and then mixed with 2 g of carriers at 150 rpm for 15 minutes. Then, a blow-off charge amount (Vertex Co.) was measured by a common method of measuring a charge amount of binary toner.
1) 10° C./10%, 2) 25° C./55%, 3) 32° C./80%

The results of the evaluation are shown in Table 1 below.

TABLE 1

| | Storage | Fixing | | | |
|---|---|---|---|---|---|
| | stability | temperature | Charge stability against | | |
| | at high | range | environmental changes (μC/g) | | |
| | temperature | (° C.) | 10° C./10% | 25° C./55% | 32° C./80% |
| Example 1 | ∘ | 130-200 | −22.5 | −23.0 | −21.9 |
| Example 2 | ∘ | 130-210 | −22.8 | −23.2 | −22.0 |
| Example 3 | ∘ | 150-220 | −22.8 | −23.1 | −21.8 |
| Example 4 | ∘ | 130-190 | −24.8 | −25.1 | −23.5 |
| Example 5 | ∘ | 130-200 | −24.8 | −25.1 | −23.5 |
| Example 6 | ∘ | 150-220 | −24.8 | −26.1 | −25.5 |
| Comparative | x | 130-170 | −24.1 | −22.2 | −16.9 |
| Example 1 | | | | | |

Referring to Table 1, storage stability at high temperatures of the toner prepared in Examples 1 to 6 was better than that prepared in Comparative Example 1. In addition, the fixing temperature range of the toner prepared in Examples 1 and 5 was in the range of 130 to 200° C., the fixing temperature ranges of the toner prepared in Examples 2 and 4 were in the range of 130 to 210° C. and 130 to 190° C., respectively, and the fixing temperature range of the toner prepared in Comparative Example 1 was in the range of 130 to 170° C. Thus, the fixing temperature range of the toner prepared in Examples 1, 2, 4, and 5 is wider than that prepared in Comparative Example 1. Accordingly, it can be seen that the toner prepared in Examples 1, 2, 4, and 5 has higher fixing performance at high temperatures and resistance to hot offset than the toner prepared in Comparative Example 1. The fixing temperature range of the toner prepared in Examples 3 and 6 was in the range of 150 to 220° C., which shows less fixing performance at low temperatures but higher fixing performance at high temperatures compared to the toner prepared in Comparative Example 1. Furthermore, with regard to charge stability against environmental changes, while the variation of the charge amount of the toner of Examples 1 to 6 (maximum variation of 1.6 μC/g in Examples 4 and 5) is low as the temperature and humidity increase, the variation of the charge amount of the toner of Comparative Example 1 (maximum variation of 5.3 μC/g) is high. Thus, it can be seen that charge stability against environmental changes of the toner prepared in Examples 1 to 6 is better than that of Comparative Example 1.

As described above, toner according to the present invention has excellent performance. Since the toner including both the insoluble resin and the polyester resin with excellent fixing properties has a higher fixing temperature range than toner that includes a non-crosslinked resin, anti-offset properties, fixing properties and charge stability at high temperatures, and storage stability at high temperature are improved.

According to the present invention, a method of preparing a toner having high anti-hot offset properties in a wide temperature range by increasing a fixing temperature range and a toner prepared using the method are provided.

According to the present invention, a method of preparing a toner having high storage stability at high temperatures and a toner prepared using the method are provided.

According to the present invention, a method of preparing a toner having high charge stability against environmental changes and a toner prepared using the method are provided.

According to the present invention, an electrophotographic imaging apparatus using the toner is provided.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A toner comprising:
a binder resin that comprises an organic solvent-insoluble resin and an acid group-containing resin;
a coloring agent; and
at least one additive,
wherein the organic solvent-insoluble resin is a crosslinked polyester resin or a cyclic olefin co-polymer (COC) resin, and the ratio of the organic solvent-insoluble resin to the acid group-containing resin is in the range of 5:95 to 40:60 on a weight basis.

2. The toner of claim 1, wherein the acid group in the acid group-containing resin comprises at least one selected from the group consisting of a carboxyl group, a phosphoric acid group, a sulfonic acid group, and a sulfuric acid group.

3. The toner of claim 1, wherein the acid group-containing resin comprises a polyester resin.

4. The toner of claim 3, wherein the polyester resin has an acid value in the range of 5 to 100 mgKOH/g.

5. The toner of claim 1, wherein the additive comprises at least one selected from the group consisting of a charge control agent and a releasing agent.

6. A method of preparing a toner, the method comprising:
dry-milling an organic solvent-insoluble resin to prepare fine particles or wet-dispersing the organic solvent-insoluble resin in an organic solvent to prepare a fine suspension;
adding an acid group-containing resin, a coloring agent, and at least one additive to an organic solvent and then mixing them to prepare a toner mixture;
adding the fine particles or fine suspension of the organic solvent-insoluble resin to the toner mixture to prepare an insoluble resin-toner mixture;
adding the insoluble resin-toner mixture to a dispersion medium to prepare a fine toner suspension; and
removing the organic solvent from the fine toner suspension to prepare a toner composition,
wherein the organic solvent-insoluble resin is a crosslinked polyester resin or a cyclic olefin co-polymer (COC) resin, and the ratio of the organic solvent-insoluble resin to the acid group-containing resin is in the range of 5:95 to 40:60 on a weight basis.

7. The method of claim 6, further comprising neutralizing the acid group of the acid group-containing resin in the toner mixture or in the insoluble resin-toner mixture with a base after forming the toner mixture or forming the insoluble resin-toner mixture.

8. The method of claim 6, further comprising aggregating the toner composition; melt-adhering the aggregated toner composition; and forming toner particles by washing and drying the melt-adhered toner composition, after preparing the toner composition.

9. The method of claim 6, wherein a diameter of fine particles prepared by dry-milling the organic solvent-insoluble resin or fine particles in the fine suspension prepared by wet-dispersing the organic solvent-insoluble resin in an organic solvent is in the range of 1 to 5 μm.

10. The method of claim 6, wherein the acid group in the acid group-containing resin comprises at least one selected from the group consisting of a carboxyl group, a phosphoric acid group, a sulfonic acid group, and a sulfuric acid group.

11. The method of claim 6, wherein the acid group-containing resin comprises a polyester resin.

12. The method of claim 11, wherein the polyester resin has an acid value in the range of 5 to 100 mgKOH/g.

13. The method of claim 6, wherein the coloring agent is in the form of a coloring pigment master batch.

14. The method of claim 6, wherein the additive comprises at least one selected from the group consisting of a charge control agent and a releasing agent.

15. The method of claim 6, wherein the dispersion medium comprises at least one selected from the group consisting of a polar solvent, a surfactant, and a thickener.

16. An electrophotographic imaging apparatus using a toner according to claim 1.
